(19) United States
(12) Patent Application Publication
(10) Pub. No.: US 2019/0358785 A1
(43) Pub. Date: Nov. 28, 2019

(54) SOCKET

(71) Applicant: TAI-YI ENTERPRISE CO., LTD., Taichung City (TW)

(72) Inventor: Ming-Fen Wu, Taichung City (TW)

(21) Appl. No.: 15/989,207

(22) Filed: May 25, 2018

(51) Int. Cl. B25B 13/06; B25B 23/00

(52) U.S. Cl. CPC B25B 13/06; B25B 23/0035

(57) ABSTRACT

A socket includes: a main body, having a combination end and working end; and a reflective body, configured on an outside of the main body, where the reflective body is provided with a reflective agent or UV developer, thereby reflecting light.

### (a) TECHNICAL FIELD OF THE INVENTION

The present invention relates to a socket tool, and more particularly to a socket having a light reflection function.

### (b) DESCRIPTION OF THE PRIOR ART

Current socket tools are improved a lot in structure or function, and the functions and technologies thereof are matured gradually. However, sockets are easy to drop or roll into the base of equipment upon replacement, which causes them to be difficult to be identified and found; it is very inconvenient for users.

### SUMMARY OF THE INVENTION

To overcome the disadvantages mentioned above, the present invention is proposed.

The present invention proposes a socket, including: a main body, having a combination end and working end; and a reflective body, configured on an outside of the main body, where the reflective body is provided with a reflective agent or UV developer, thereby reflecting light.

The main body may be configured with a groove, and the reflective body may be a reflective agent or UV developer and coated directly on the groove, thereby reflecting light.

### BRIEF DESCRIPTION OF THE DRAWINGS

FIG. 1 is a perspective view of a first preferred embodiment of the present invention;

FIG. 2 is a cross-sectional view of the first embodiment of the present invention;

FIG. 3 is an exploded view of a second preferred embodiment of the present invention;

FIG. 4 is a cross-sectional view of the second embodiment of the present invention; and

FIG. 5 is a perspective view of a third preferred embodiment of the present invention.

### DETAILED DESCRIPTION OF THE PREFERRED EMBODIMENTS

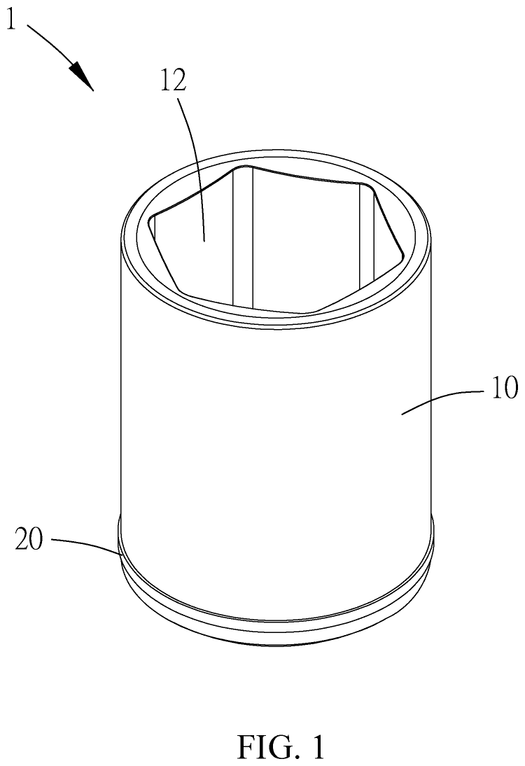

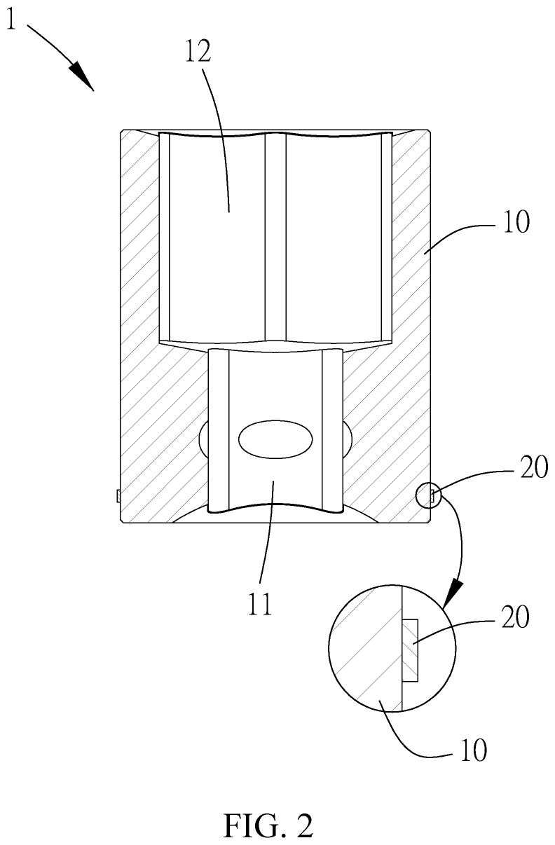

Referring to FIGS. 1 and 2, a socket of the present invention, in a first preferred embodiment, includes a main body 10 and reflective body 20.

The main body 10 has a combination end 11 and working end 12.

The reflective body 20 is configured on the outside of the main body 10, where the outside of the reflective body 20 is coated with a reflective agent (not shown in the figures) or UV developer (not shown in the figures), thereby reflecting light.

The above reflective body 20 has elasticity and at least one color so as to be convenient for use and identification.

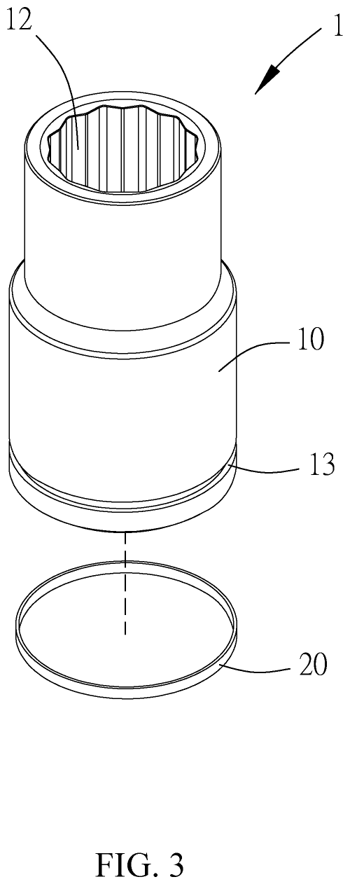

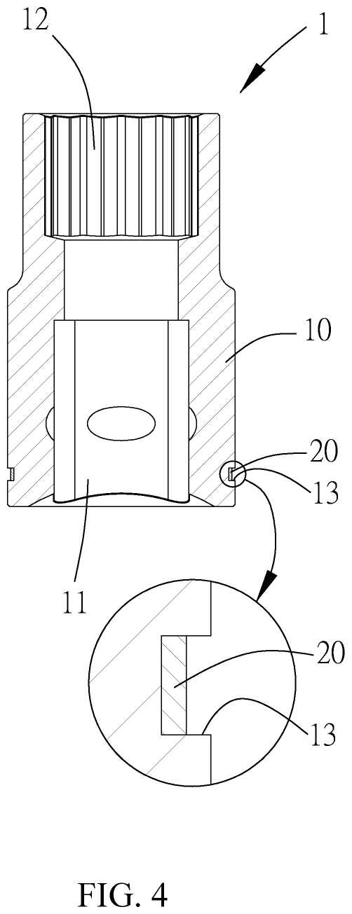

Referring to FIGS. 3 and 4, the main body 10 of the present invention, in a second preferred embodiment, is configured with an annular groove 13 on the outside thereof, and the reflective body 20 is configured on the annular groove 13. In the embodiment, the outside of the reflective body 20 is coated with a reflective agent (not shown in the figures) or UV developer (not shown in the figures), thereby reflecting light.

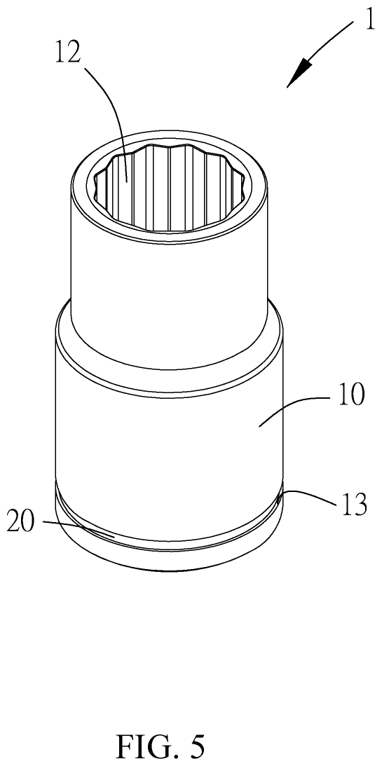

Referring to FIG. 5, the reflective body 20 of the present invention, in a third preferred embodiment, is a reflective agent or UV developer coated on the annular groove 13.

I claim:

1. A socket, comprising:
a main body, having a combination end and working end; and
a reflective body, configured on an outside of said main body, thereby reflecting light.

2. The socket according to claim 1, wherein said outside of said main body is configured with an annular groove, and said reflective body is configured on said annular groove.

3. The socket according to claim 2, wherein an outside of said reflective body is coated with a reflective agent or UV developer.

4. The socket according to claim 3, wherein said reflective body has elasticity and at least one color.

5. The socket according to claim 2, wherein said reflective body is a reflective agent or UV developer coated on said annular groove.
